(19) United States
(12) Patent Application Publication
(10) Pub. No.: US 2022/0029450 A1
(43) Pub. Date: Jan. 27, 2022

(54) Power Generating Shed Assembly

(71) Applicant: Mark Singleton, Pell City, AL (US)

(72) Inventor: Mark Singleton, Pell City, AL (US)

(21) Appl. No.: 16/935,846

(22) Filed: Jul. 22, 2020

(51) Int. Cl. H02J 7/35; H02J 7/00

(52) U.S. Cl. CPC H02J 7/35; H02J 7/0029; H02J 7/0013; H02J 7/0042

(57) ABSTRACT

A power generating shed assembly for simultaneously storing and charging batteries of cordless power tools includes a shed that has a roof, a floor and four exterior walls. A plurality of solar panels is provided and each of the solar panels is coupled to the roof to be exposed to sunlight. A control unit is positioned inside the shed and the control unit is in electrical communication with each of the solar panels such that the control unit receives electrical current from the solar panels. A plurality of batteries is each in electrical communication with the control unit thereby facilitating the solar panels to charge the batteries. A plurality of charging units is each electrically coupled to the batteries for charging rechargeable batteries.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shed devices and more particularly pertains to a new shed device for simultaneously storing and charging batteries of cordless power tools.

### (2) Description of Related Art Including Information Disclosed Under 37 CFR 1.97 and 1.98

The prior art relates to shed devices including a shed with solar panels and a voltage regulator. The prior art discloses a charging device that includes a solar panel that is mounted in the bed of a pickup for charging rechargeable batteries. The prior art discloses a system and method for managing power consumption and storage which includes solar panels and power conditioning electronics. The prior art discloses a solar panel that is integrated into roof sheathing for covering a roof of a building. The prior art also discloses an improved design for a solar panel.

### BRIEF SUMMARY OF THE INVENTION

An embodiment of the disclosure meets the needs presented above by generally comprising a shed that has a roof, a floor and four exterior walls. A plurality of solar panels is provided and each of the solar panels is coupled to the roof to be exposed to sunlight. A control unit is positioned inside the shed and the control unit is in electrical communication with each of the solar panels such that the control unit receives electrical current from the solar panels. A plurality of batteries is each in electrical communication with the control unit thereby facilitating the solar panels to charge the batteries. A plurality of charging units is each electrically coupled to the batteries for charging rechargeable batteries.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a power generating shed assembly according to an embodiment of the disclosure.

FIG. 2 is a right side view of an embodiment of the disclosure.

FIG. 3 is a schematic view of an embodiment of the disclosure.

FIG. 4 is a cross sectional view taken along line 4-4 of FIG. 2 of an embodiment of the disclosure.

FIG. 5 is a detail view taken from circle 5 of FIG. 2 of an embodiment of the disclosure.

### DETAILED DESCRIPTION OF THE INVENTION

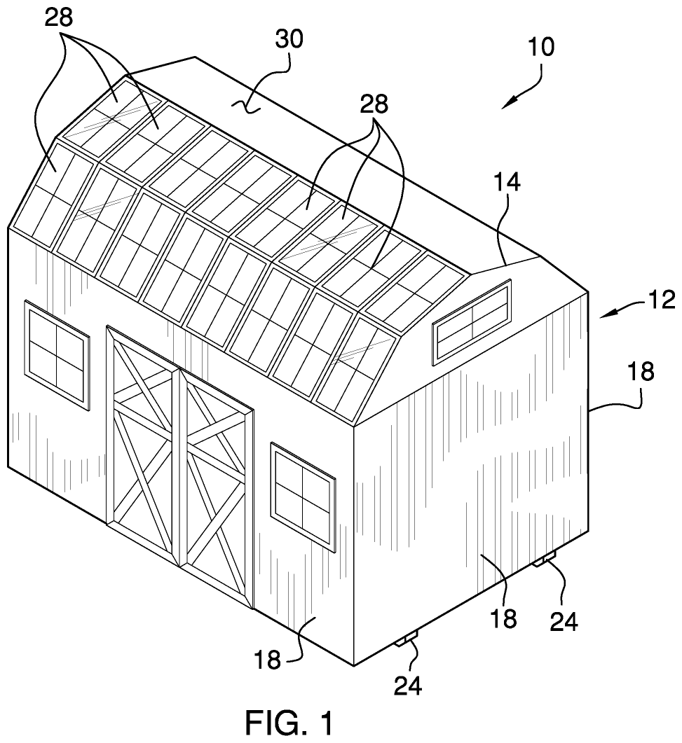

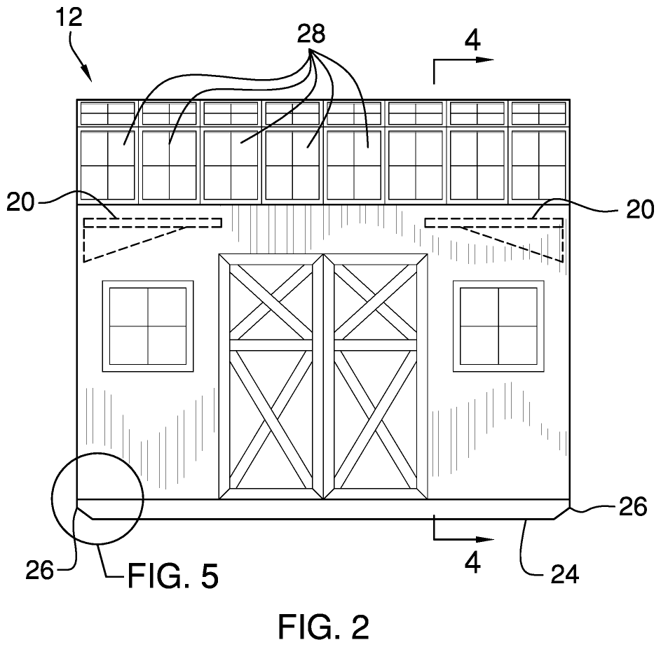

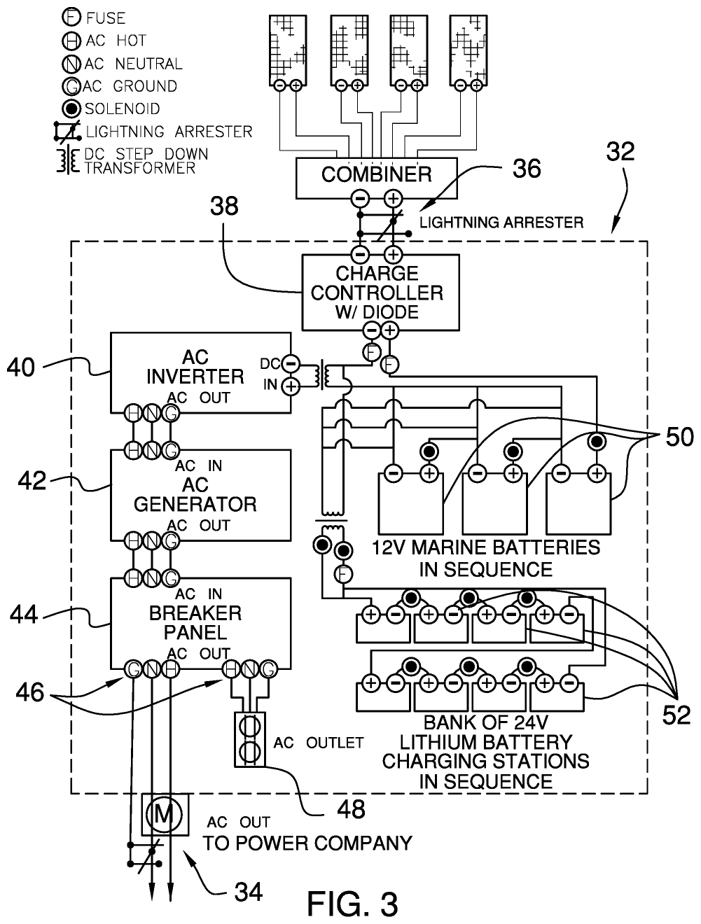

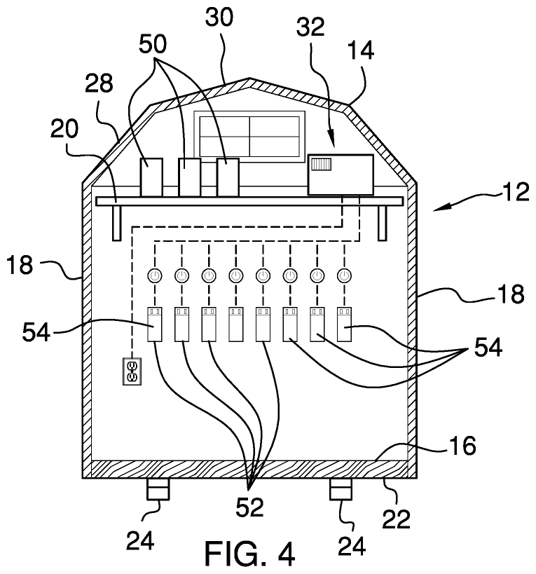

With reference now to the drawings, and in particular to FIGS. 1 through 5 thereof, a new shed device embodying the principles and concepts of an embodiment of the disclosure and generally designated by the reference numeral 10 will be described.

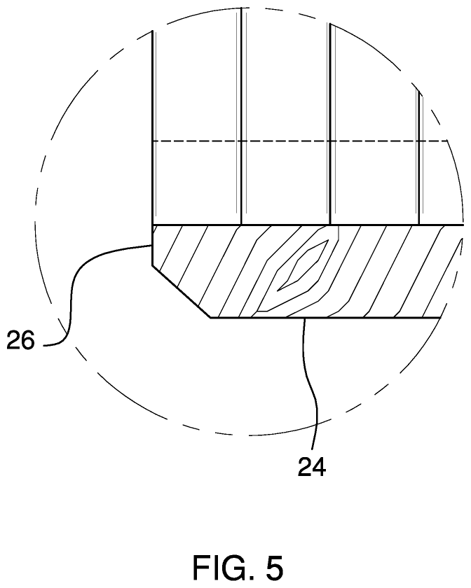

As best illustrated in FIGS. 1 through 5, the power generating shed assembly 10 generally comprises a shed 12 has a roof 14, a floor 16 and four exterior walls 18. The shed 12 has a pair of lofts 20 within an interior of the shed 12 and the floor 16 has a bottom surface 22. The bottom surface 22 has a pair of skids 24 each coupled thereto and each of the skids 24 is oriented parallel to each other thereby facilitating the shed 12 to be transported on the skids 24. As is most clearly shown in FIG. 5, each end 26 of each skid 24 may be beveled to inhibit the skids 24 from digging into the ground when the shed 12 is being dragged on the skids 24.

A plurality of solar panels 28 is provided and each of the solar panels 28 is coupled to the roof 14 such that each of the solar panels 28 is exposed to sunlight. Each of the solar panels 28 is positioned on an outside surface 30 of the roof 14. A control unit 32 is positioned inside the shed 12 and the control unit 32 is in electrical communication with each of the solar panels 28 such that the control unit 32 receives electrical current from the solar panels 28. The control unit 32 conditions the electrical current into direct current. Additionally, the control unit 32 is in electrical communication with an electric utility power line 34 for releasing excess electrical current into the electric utility power line 34. The control unit 32 is positioned in a respective one of the lofts 20 in the shed 12 thereby inhibiting the control unit 32 from occupying floor 16 space in the shed 12.

The control unit 32 comprises a lightning arrestor 36 that is positioned in the shed 12. The lightning arrestor 36 is electrically coupled to each of the solar panels 28 to absorb voltage from a lightning strike. The control unit 32 includes a charge controller 38 that is electrically coupled to the lightning arrestor 36 such that the charge controller 38 receives the electrical current from the solar panels 28. The charge controller 38 may comprise a solid state charge controller 38 for controlling solar panel output.

The control unit 32 includes an inverter 40 that is positioned in the shed 12. The inverter 40 is electrically coupled to the charge controller 38 to convert the electrical current from the solar panels 28 into alternating current. The inverter 40 may be an electronic inverter 40 of any conventional design. A generator 42 is positioned in the shed 12 and the generator 42 is electrically coupled to the inverter 40 for receiving the alternating current from the inverter 40. The generator 42 may comprise an alternating current generator of any conventional design.

The control unit 32 includes a breaker panel 44 that is positioned in the shed 12. The breaker panel 44 is electrically coupled to the generator 42 for receiving the alternating current from the generator 42. Additionally, the breaker panel 44 has a pair of outputs 46, and a respective one of the outputs 46 is electrically coupled to the electric utility power line 34. The breaker panel 44 may be any electrical breaker panel that conforms to the National Electrical Code. The control unit 32 includes a female electrical outlet 48 that is positioned in the shed 12. The female electrical outlet 48 is electrically coupled to a respective one of the outputs 46 on the breaker panel 44 to facilitate power for an electronic device.

A plurality of batteries 50 is included and each of the batteries 50 is positioned inside the shed 12. Each of the batteries 50 is in electrical communication with the control unit 32 thereby facilitating the solar panels 28 to charge the batteries 50. Moreover, each of the batteries 50 is electrically coupled to the charge controller 38 for receiving electrical current from the charge controller 38. Each of the batteries 50 is positioned in a respective one of the lofts 20 such that the batteries 50 do not occupy any floor 16 space in the shed 12. Each of the batteries 50 may be a deep cycle wet cell battery or other type of battery commonly employed for storing solar energy.

A plurality of charging units 52 is provided and each of the charging units 52 is positioned in the shed 12. Each of the charging units 52 is electrically coupled to the batteries 50. Each of a plurality of rechargeable batteries 54 is each positionable in a respective one of the charging units 52 for charging the rechargeable batteries 54. Each of the charging units 52 may be battery chargers associated with cordless power tools, and each of the rechargeable batteries 54 may be a lithium ion battery or other similar type of rechargeable battery commonly employed with cordless power tools.

In use, each of the cordless power tools is stored in the shed 12 and the rechargeable battery 54 for each of the cordless power tools is positioned in the respective charging unit 52. In this way all of the rechargeable batteries 54 are recharged while the cordless power tools are being stored. Thus, the cordless power tools will have a full charge each time they are used. Additionally, the solar panels 28 eliminate the cost of electricity for charging the rechargeable batteries 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A power generating shed assembly for storing and charging a plurality of batteries for cordless power tools, said assembly comprising:
a shed having a roof, a floor and four exterior walls;
a plurality of solar panels, each of said solar panels being coupled to said roof wherein each of said solar panels is configured to be exposed to sunlight;
a control unit being positioned inside said shed, said control unit being in electrical communication with each of said solar panels such that said control unit receives electrical current from said solar panels, said control unit conditioning the electrical current into direct current, said control unit being in electrical communication with a electric utility power line for releasing excess electrical current into the electric utility power line;
a plurality of batteries, each of said batteries being positioned inside said shed, each of said batteries being in electrical communication with said control unit thereby facilitating said solar panels to charge said batteries; and
a plurality of charging units, each of said charging units being positioned in said shed, each of said charging units being electrically coupled to said batteries, each of said charging units having a respective one of a plurality of rechargeable batteries coupled thereto wherein each of said charging units is configured to charge the rechargeable batteries.

2. The assembly according to claim 1, wherein said shed has a pair of lofts within an interior of said shed, said floor having a bottom surface, said bottom surface having a pair of skids each being coupled thereto, each of said skids being oriented parallel to each other thereby facilitating said shed to be transported on said skids.

3. The assembly according to claim 2, wherein said control unit is positioned in a respective one of said lofts.

4. The assembly according to claim 1, wherein said control unit comprises a lightning arrestor being positioned in said shed, said lightning arrestor being electrically coupled to each of said solar panels wherein said lighting arrestor is configured to absorb voltage from a lightning strike.

5. The assembly according to claim 4, wherein said control unit comprises a charge controller being electrically coupled to said lightning arrestor such that said charge controller receives the electrical current from said solar panels.

6. The assembly according to claim 5, wherein said control unit includes an inverter being positioned in said shed, said inverter being electrically coupled to said charge controller wherein said inverter is configured to convert the electrical current from said solar panels into alternating current.

7. The assembly according to claim 6, wherein said control unit includes a generator being positioned in said shed, said generator being electrically coupled to said inverter for receiving the alternating current from said inverter.

8. The assembly according to claim 7, wherein said control unit includes a breaker panel being positioned in said shed, said breaker panel being electrically coupled to said generator for receiving the alternating current from said generator, said breaker panel having a pair of outputs, a respective one of said outputs being electrically coupled to the electric utility power line.

9. The assembly according to claim 8, wherein said control unit includes a female electrical outlet being positioned in said shed, said female electrical outlet being electrically coupled to a respective one of said outputs on said breaker panel wherein said female electrical outlet is configured to facilitate power for an electronic device.

10. The assembly according to claim 5, wherein each of said batteries is electrically coupled to said charge controller for receiving electrical current from said charge controller.

11. The assembly according to claim 2, wherein each of said batteries is positioned in a respective one of said lofts.

12. A power generating shed assembly for storing and charging a plurality of batteries for cordless power tools, said assembly comprising:
a shed having a roof, a floor and four exterior walls, said shed having a pair of lofts within an interior of said shed, said floor having a bottom surface, said bottom surface having a pair of skids each being coupled thereto, each of said skids being oriented parallel to each other thereby facilitating said shed to be transported on said skids;
a plurality of solar panels, each of said solar panels being coupled to said roof wherein each of said solar panels is configured to be exposed to sunlight, each of said solar panels being positioned on an outside surface of said roof;
a control unit being positioned inside said shed, said control unit being in electrical communication with each of said solar panels such that said control unit receives electrical current from said solar panels, said control unit conditioning the electrical current into direct current, said control unit being in electrical communication with a electric utility power line for releasing excess electrical current into the electric utility power line, said control unit being positioned in a respective one of said lofts, said control unit comprising:
a lightning arrestor being positioned in said shed, said lightning arrestor being electrically coupled to each of said solar panels wherein said lighting arrestor is configured to absorb voltage from a lightning strike;
a charge controller being electrically coupled to said lightning arrestor such that said charge controller receives the electrical current from said solar panels;
an inverter being positioned in said shed, said inverter being electrically coupled to said charge controller wherein said inverter is configured to convert the electrical current from said solar panels into alternating current;
a generator being positioned in said shed, said generator being electrically coupled to said inverter for receiving the alternating current from said inverter;
a breaker panel being positioned in said shed, said breaker panel being electrically coupled to said generator for receiving the alternating current from said generator, said breaker panel having a pair of outputs, a respective one of said outputs being electrically coupled to the electric utility power line; and
a female electrical outlet being positioned in said shed, said female electrical outlet being electrically coupled to a respective one of said outputs on said breaker panel wherein said female electrical outlet is configured to facilitate power for an electronic device;
a plurality of batteries, each of said batteries being positioned inside said shed, each of said batteries being in electrical communication with said control unit thereby facilitating said solar panels to charge said batteries, each of said batteries being electrically coupled to said charge controller for receiving electrical current from said charge controller, each of said batteries being positioned in a respective one of said lofts; and
a plurality of charging units, each of said charging units being positioned in said shed, each of said charging units being electrically coupled to said batteries, each of said charging units having a respective one of a plurality of rechargeable batteries coupled thereto wherein each of said charging units is configured to charge the rechargeable batteries.
